(19) United States
(12) Patent Application Publication
(10) Pub. No.: US 2006/0127840 A1
(43) Pub. Date: Jun. 15, 2006

(54) Dental treatment unit with measuring device and three-dimensional measuring device

(75) Inventors: Peter Fornoff, Reichelsheim (DE); Harald Hamann, Bensheim (DE); Gunther Moritz, Lampertheim (DE); Markus Nicklas, Weinheim (DE); Josef Pabst, Heddesheim (DE); Roger Schron, Birkenau (DE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: SIRONA DENTAL SYSTEMS GMBH

(21) Appl. No.: 11/206,832

(22) Filed: Aug. 19, 2005

(30) Foreign Application Priority Data
Dec. 14, 2004 (DE) 10 2004 060 406.1

(51) Int. Cl. A61C 13/38; A61C 3/00

(52) U.S. Cl. 433/77; 433/29

(57) ABSTRACT

A dental treatment unit including at least one mechanical connection for a three-dimensional measuring device for the measurement of teeth, treatment situations and tooth models. The three-dimensional measuring device and the dental treatment unit may be connected to each other by way of means for the exchange of data and/or control commands. In another embodiment, the three-dimensional measuring device may be configured for the three-dimensional measurement of teeth, treatment situations and tooth models, and include a hand-held piece with an image acquisition unit and a base unit that is connected to hand-held piece. The base unit may include means for the exchange of data and/or control commands with a dental treatment unit and/or means for the supply of power through the dental treatment unit.

### RELATED APPLICATIONS

The present application claims the benefit of priority to German Patent Application No. 10 2004 060 406.1, filed Dec. 14, 2004.

### BACKGROUND OF INVENTION

a. Field of Invention

The invention relates generally to dental equipment, and, more particularly to a dental treatment unit operatively connected to a three-dimensional measuring device for the measurement of teeth, treatment situations and tooth models.

b. Description of Related Art

Three-dimensional measuring devices for measuring teeth and tooth models are well known in the art. W001/80761 discloses one such measuring device which includes a hand-held piece for recording an image and a base for controlling the hand-held piece, for converting the image data and for forwarding the recorded data to a computing unit.

Measuring devices of the type disclosed in W001/80761 are however realized as independent devices, which means that for their use, each device needs its own power supply and its own positioning location. In most dental offices, additional external devices are viewed as disruptive and as an impediment because the available space in the environment of the treatment unit is usually limited. Moreover, the measuring unit must be moved towards the treatment unit in a special step before any planned image acquisition.

It is therefore an object of the present invention to provide a dental treatment unit that offers the possibility of operating the unit in conjunction with a three-dimensional measuring device, while allowing the three-dimensional measuring device to be functional without any need for additional space, and to be easily accessible.

### SUMMARY OF INVENTION

The invention achieves the aforementioned exemplary objects by providing a dental treatment unit including at least one mechanical connection for a three-dimensional measuring device for the measurement of teeth, treatment situations and tooth models. The three-dimensional measuring device and the dental treatment unit may be equipped with means for the exchange of data and/or control commands and/or for supplying energy to the three-dimensional measuring device connecting both devices to each other. In this manner, it may be possible to combine the three-dimensional measuring device and the dental treatment unit into a single unit.

Advantageously, the dental treatment unit may be configured in such a way that it includes a drawer or shelf that offers room for inserting at least a base part of the three-dimensional measuring device or upon which the three-dimensional measuring device is deposited. This arrangement may allow for integration of the measuring device inside the dental treatment unit without the need of having to provide additional positioning space.

Moreover, the three-dimensional measuring device may be partially integrated with the dental treatment unit. Correspondingly, the power supply and/or communication means and/or storage and computing functions can be integrated in the dental treatment unit, and the three-dimensional measuring device can be constructed in a compact configuration.

The connection for the three-dimensional measuring device may be installed on a dentist's element and/or on an assistant's element and/or on a graphic display means and/or on the treatment chair. This allows for an ergonomic and space-saving integration of the three-dimensional measuring device dependent on the respective requirements by the operator of the three-dimensional measuring device.

Advantageously, the base part of the three-dimensional measuring device may be removable by hand. If so, the three-dimensional measuring device can then be inserted in a drawer for the three-dimensional device and again removed without the use of further auxiliary means. To secure the device against undesired removal, the drawer can be configured in such a way that the base part of the three-dimensional device snaps in place. Usually a dentist has more than one treatment room and can in such a case use the three-dimensional device in each of the treatment rooms. All that is needed is the purchase of a three-dimensional device that is suitable for use in several treatment rooms.

Advantageously, the three-dimensional measuring device may include a hand-held instrument for the recording of the image. The instrument can be inserted into the mouth and is able to take measurements of the oral cavity. The hand-held instrument may transmit the recorded data to an image acquisition unit that is incorporated in the three-dimensional measuring device. The data may be digitized at that location and made available via an interface. The interface can be cable-supported or configured as wireless. A measuring device of this type can be more flexible than a measuring device with a fixedly installed camera, and allows the operator of the three-dimensional measuring device to freely select the image section that is to be recorded. In a particular configuration, the image acquisition unit may be integrated as part of the hand-held instrument.

Advantageously, a central control unit on the dental treatment unit may control the functions and interfaces of the dental treatment unit at least in part. With a central control unit of this kind, it may be possible to monitor and control all important functions of the dental treatment unit and, moreover, to receive, via the interface of the dental treatment unit, incoming data as well as provide the data that are to be made available via the interfaces.

An interface may be provided on the dental treatment unit for the hook-up of external equipment that can be used for bi-directional data transmissions. This interface may include a data connection with the interface to the three-dimensional measuring unit via the internal control unit and include the ability to send and receive data, e.g. measured data or a live image and/or control commands, e.g. image triggering or input means, to and from the three-dimensional measuring device. This makes it possible to integrate further functionalities in the dental treatment unit that will support the dentist when he/she conducts a treatment or diagnosis. Furthermore, a more far-reaching integration of the three-dimensional measuring device in the dental treatment unit becomes possible. The three-dimensional measuring device may also be designed without further data transmission means.

Advantageously, a computer with at least one interface may be provided in addition to the dental treatment unit, and a computer program may be stored in the computer and called up to process data from the three-dimensional measuring device. In this manner, it may be possible to store and evaluate data gathered by the three-dimensional measuring device already on site.

The computer may be integrated in the central control unit of the dental treatment unit, thereby rendering the use of an external computer unnecessary and preventing problems related to compatibility and space requirements.

Alternatively, it may be possible to connect an interface of the three-dimensional measuring unit with an interface of the computer. In the case of interfaces that are configured as wireless, this connection may save a detour through the central control unit. Thereby it may be possible to forego use of a central control unit or to configure the central control unit in a simpler fashion while measured data is nevertheless evaluated immediately in the computer.

The functions of the three-dimensional measuring device may be triggered by control signals of an operating element belonging to the treatment unit. Such an operating element may be a foot-operated switch or also a switch of the dentist's element or assistant's element. Further control signalers may also be used. Operation of the three-dimensional measuring device by means of operating elements of the dental treatment unit may render the operating elements of the three-dimensional measuring device superfluous for the most part. The three-dimensional measuring device may be ergonomically configured and easily controlled by operating elements that are known to the operator.

Advantageously, at least two input means may be provided on the three-dimensional device and/or on the dental treatment unit in order to trigger certain functions of the three-dimensional measuring device. This allows, for example, an assistant to trigger a measurement if the dentist must take a position for effecting the measurement that makes it difficult for him/her to trigger the measurement himself/herself.

The dental treatment unit or the three-dimensional measuring device or the computer may include means that recognize control commands in the form of sound sequences and/or speech and include the ability to convert them into the corresponding control signals for executing functions of the treatment unit or of the three-dimensional measuring device. This may allow, for example, for triggering a measurement by means of a voice command with neither the dentist nor the assistant having to activate any switch. This may therefore minimize the risk of faulty images due to positioning changes.

Advantageously, a time gap of less than 0.2 seconds may be provided between the issuance of the control command and the generation of the control signal. A longer time delay may result in the risk of inaccuracies or positioning errors and should therefore be avoided in a practical setting. The generation of a sound signal may be registered and processed via voice control means that have, in contrast to voice recognition means that attempt to realize all sound sequences, a reduced and clearly preset instruction set. But this reduced instruction set may be quickly recognized resulting in delay times of 10 milliseconds. The voice control may also reliably function in the presence of interference noise such as from an activated suction element.

The present invention also provides patient positioning means for allowing to bring the patient, depending on the measurement that is to be effected, automatically into a position that is convenient for the operator of the three-dimensional device. For example, if more than one image is needed for the measurement of a treatment situation in the patient's mouth, the patient may have to be repositioned. The work of the operator may be facilitated if the patient is brought automatically into a subsequent position that is favorable for the next measurement.

The dental treatment unit may be equipped with at least one graphic display means. Data specific to the equipment and/or the patient can be viewed by way of such a display means.

Advantageously, at least one display means may be provided for showing data that are relevant for the measurement and/or for displaying output by the computer. The person providing the treatment may then able to check the success of a previous measurement by way of a display means arranged in his/her field of vision, and he/she may repeat any measurements that may have been unsuccessful immediately.

Advantageously, at least one graphic display means of the dental treatment unit may be equipped with a touch-sensitive and location-resolving surface as well as further evaluation means that evaluate pressure applied to the surface and that transmit subsequent control signals to the treatment unit and/or the computer and/or the three-dimensional measuring device. A touch screen of this kind may facilitate the implementation of a measurement and/or of a treatment because necessary control commands, for example the storage of an image, a further measurement etc., may be possible without the need for further operating elements.

Alternatively, several graphic display means may be provided and be configured to show respectively different pieces of information. This way, it may be possible to supply several persons who are involved with the providing of the treatment each with the data that is respectively relevant for them. For example, the assistant could view such information as it relates to the administration of the image data, and the dentist could view a display of the recorded area.

Advantageously, the dental treatment unit may be equipped with motor-driven adjustment means that bring at least one of the graphic display means into a position that is convenient for the operator of the three-dimensional measuring device. Thus, it may be possible for the operator of the three-dimensional device to work within the treatment situation without having to significantly avert his/her view from the treatment situation for the purpose of reading data off the graphic display.

Advantageously, a recording plan may be stored in the central control unit and/or in the computer based upon which the position that is convenient for the operator of the three-dimensional measuring device of the graphic display means and/or of the treatment chair, equipped with motor-driven adjustment means, is determined by a computer or by the central control unit. Consequently, operating comfort may be improved and the treatment process accelerated.

The computer program used on the computer may include means for detecting the tooth type and preferably the recording direction and may further include evaluation means in order to determine based on a recording plan the most favorable position for the next necessary image recording, plus it may include means for transmitting corresponding control signals by way of the interface of a computer, which is connected to the interface for the hook-up of external equipment of the dental treatment unit, to the patient positioning means and/or display means of the dental treatment unit. These kinds of functions of the computer program may enhance operating comfort further and prevent, moreover, the recording of faulty images.

A shelf may be provided for the hand-held instrument of the three-dimensional measuring device equipped with sensing means that recognize the deposition and removal of the measuring device, and further signaling means may be provided that transmit the status of the shelf of the hand-held instrument by way of an interface of the three-dimensional measuring device. Thus, it may be possible to bring the dental treatment unit into a state that is required for the recording the image while showing the corresponding information on the graphic display means.

The dental treatment unit and the computer program that is stored in the computer may be transferred into a state that is necessary for the measurement when the hand-held instrument is removed from its correspondingly envisioned shelf. Consequently, other functions of the dental treatment unit and/or of the computer can be stopped this way and the computer program can be brought into a ready-state for recording an image.

Advantageously, the dental treatment unit and/or the three-dimensional measuring device and/or the computer may include an interface for transmitting measured data to a local or remote network. Measured data can thus, for example, be stored in a central database or transmitted to a dental laboratory that produces a tooth replacement on the basis of the measured data. This process may accelerate the production of the tooth replacement products thereby shortening the treatment time.

A further object of the present invention relates to a three-dimensional measuring device for the measurement of teeth, treatment situations and tooth models relating to a hand-held instrument including an image acquisition unit and a base unit that is connected to the hand-held instrument. The base unit may include means for effecting exchanges of data and/or of control commands with the dental treatment unit and/or means for supplying energy through the dental treatment unit. A measuring device of such a kind can easily be integrated as part of a dental treatment unit and considerably facilitates the work processes for the person operating the unit.

In an exemplary embodiment of the three-dimensional measuring device, the three-dimensional measuring device may be equipped with connecting means so that it can be attached at locations envisioned for this purpose on the dental treatment unit. This allows for the integration of the three-dimensional measuring device without having to use up positioning space that may be needed for other purposes, if necessary.

Advantageously, the connecting means of the three-dimensional measuring device may be configured in such a way that the three-dimensional measuring device can be detached by hand from the dental treatment unit. This way, the three-dimensional measuring device can, if necessary, be used in multiple treatment rooms thereby rendering the purchase of several three-dimensional measuring devices superfluous.

Advantageously, a shelf may be provided on the base unit of the three-dimensional measuring device for depositing the hand-held instrument.

The shelf may include sensing means that transmit the status of the shelf via signaling means by way of one of the interfaces of the three-dimensional device. This way, it may be possible to recognize the state when the hand-held instrument has been removed, and, if necessary, other components of the treatment unit can be brought into a status that is necessary for effecting the measurement.

The three-dimensional measuring unit may include an image acquisition device that digitizes the three-dimensional measured data and makes them available by an interface. Measured data pre-treated in this manner can be transmitted without loss of quality to units for storage and/or evaluation.

The three-dimensional device may be connected by an interface to the dental treatment unit. Measured data can then be transmitted directly to the dental treatment unit, for example, for display on a monitor that is connected to the dental treatment unit.

One interface of the three-dimensional measuring device may be connected to a computer. This allows for direct storage and evaluation of measured data.

The image recording functions of the three-dimensional measuring device may be triggered by the means for the exchange of data and/or control commands. Controlling the three-dimensional measuring device may then also possible by using operating elements of the dental treatment unit.

Means for the exchange of data and/or control commands may be configured in such a way that the measured data can be transmitted by the three-dimensional device to a local or remote network. The measured data can then, for example, be stored in a database or transmitted directly to a dental laboratory for the production of tooth replacement products.

Advantageously, the three-dimensional device may include means that recognize control commands in the form of sound sequences and/or voice. This way, it is possible to control the three-dimensional measuring device without the mechanical activation of operating elements, e.g. in order to trigger a measurement. Operation of the three-dimensional measuring device may thus be made easier and positioning errors are avoided, thereby increasing the recording reliability.

The present invention thus achieves the aforementioned exemplary objects and advantages by providing a dental treatment unit including at least one mechanical connection for a three-dimensional measuring device for measurement of teeth, treatment situations and tooth models. The three-dimensional measuring device and the dental treatment unit may be connected by means for exchange of data, control commands, and/or supply of power to the three-dimensional measuring device.

For the dental treatment unit described above, the unit may include a drawer or a shelf in which is inserted or deposited at least a base part of the three-dimensional measuring device. The three-dimensional measuring device may be partially integrated in the dental treatment unit. The connection may be mounted on a dentist's element, on an assistant's element, on a graphic display means and/or in a treatment chair. The base part of the three-dimensional measuring device may be removable by hand. The three-dimensional measuring device may include a hand-held instrument for recording of an image that transmits the recorded data to an image acquisition unit incorporated in the three-dimensional measuring device where the data are digitized and made available via an interface.

The dental treatment unit may further include a central control unit in the dental treatment unit, with the central control unit controlling at least in part functions and interfaces of the dental treatment unit. An interface may be provided on the dental treatment unit for connecting external equipment through which data can be transmitted bi-directionally, and the interface may be configured in such a way that the interface establishes a connection via the central control unit with the interface of the three-dimensional measuring device for the transmission of data and/or control commands. A computer may be provided with at least one interface, with the computer being capable of storing and calling up a computer program for processing data from the three-dimensional measuring device. The computer may be integrated in the central control unit. An interface of the three-dimensional measuring device may be connected to an interface of the computer. Functions of the three-dimensional measuring device may be triggered by control signals of an operating element that belongs to the dental treatment unit, and the operating element may be a foot-operated switch.

The dental treatment unit may further include at least two input means on the three-dimensional measuring device and/or on the dental treatment unit for triggering certain functions of the dental treatment unit or of the three-dimensional measuring device. The unit may also include recognizing means on the dental treatment unit or on the three-dimensional measuring device or on the computer that recognize the control commands in the form of sound sequences and/or voice, and convert the control commands to corresponding control signals for carrying out functions of the three-dimensional device. A time gap of less than 0.2 seconds may elapse between issuance of the control command and generation of the control signals. Patient positioning means may be used to automatically bring the treatment chair, dependant on the measurement that is to be effected, into a position that is convenient for an operator of the three-dimensional measuring device. A least one graphic display means may be provided on the dental treatment unit. A least one of the graphic display means may show measurement-relevant data and/or displays that are output by the computer. The computer may be equipped with a graphic display means and different measurement-relevant data and/or displays may be shown on the computer graphic display means and on at least one of the graphic display means of the dental treatment unit. The graphic display means of the dental treatment unit may include a touch-sensitive and location-resolving surface, and further may include evaluation means that evaluate pressure upon the surface and transmit control signals to the dental treatment unit, the computer, and/or the three-dimensional measuring device. Additionally, several graphic display means which are suitable for showing different kinds of information respectively may be provided.

The dental treatment unit may further include motor-driven adjusting means for bringing at least one of the graphic display means of the dental treatment unit in a position that is convenient for an operator of the three-dimensional measuring device. A recording plan may be stored in the central control unit and/or in the computer based upon which position that is convenient for an operator of the three-dimensional measuring device of the graphic display means of the dental treatment unit and/or the treatment chair is determined by the central control unit or the computer. The computer program may contain means for recognizing a tooth type and a recording direction of the image and may further include evaluation means in order to determine on basis of a recording plan a favorable position for a next necessary image and transmit corresponding control signals via the interface of the computer via the interface of the dental treatment unit to the connection of external equipment to the central control unit in order to control the patient positioning means and/or display means of the dental treatment unit.

The dental treatment unit may further include a shelf for the hand-held instrument of the three-dimensional measuring device. The shelf may contain sensing means that recognize the deposition and removal of the hand-held instrument, and may further include signaling means that transmit the status of the shelf via one of the interfaces of the three-dimensional device. The dental treatment unit and the computer program called up on the computer may be rendered into a necessary state for measurement by removal of the hand-held instrument of the three-dimensional measuring device from the shelf.

The dental treatment unit may also include an interface for transmission of measured data of the three-dimensional measuring device to a local or remote network on the dental treatment unit, the three-dimensional measuring device and/or the computer.

The invention also provides a three-dimensional measuring device for three-dimensional measuring of teeth, treatment situations and tooth models. The three-dimensional measurement device may include a hand-held piece with an image acquisition unit and a base unit that is connected to the hand-held piece. The base unit may include means for exchange of data and/or control commands with a dental treatment unit and/or means for supply of power through the dental treatment unit.

For the three-dimensional measuring device described above, the three-dimensional measuring device may be equipped with connecting means for the connection of the three-dimensional measuring device to locations on the dental treatment unit. The connecting means may be configured in such a way that the three-dimensional measuring device is detachable by hand from the dental treatment unit. A shelf may be provided for deposition of the hand-held instrument on a base unit. The shelf may contain sensing means that transmit status of the shelf via signaling means by way of one of the interfaces of the three-dimensional measuring device. The three-dimensional measuring device may include an image acquisition unit where measured data recorded with the three-dimensional measuring device are digitized and made available via an interface. The interface may be connected to the dental treatment unit and/or to a computer. Image recording functions of the three-dimensional measuring device may be triggered by means to effect exchange of data and/or control commands. The means may be designed in such a way that the three-dimensional measuring device is able to send measured data to a local or remote network. Recognizing means may be available on the three-dimensional measuring device that recognize control commands in the form of sound sequences and/or voice.

The invention yet further provides a method of measuring teeth, treatment situations and tooth models. The method may include providing a dental treatment unit including at least one mechanical connection for a three-dimensional measuring device, and connecting the three-dimensional measuring device and the dental treatment unit by the mechanical connection, and thereby exchanging data, exchanging control commands, and/or supplying power to the three-dimensional measuring device.

For the method described above, the method may further include inserting or depositing a drawer or shelf on the dental treatment unit on at least a base part of the three-dimensional measuring device, partially integrating the three-dimensional measuring device in the dental treatment unit, and/or mounting the connection on a dentist's element, on an assistant's element, on a graphic display means and/or in a treatment chair. The base part of the three-dimensional measuring device may be removable by hand.

The method may also include providing the three-dimensional measuring device with a hand-held instrument for recording of an image that transmits the recorded data to an image acquisition unit incorporated in the three-dimensional measuring device where the data are digitized and made available via an interface, and/or controlling at least in part functions and interfaces of the dental treatment unit by means of a central control unit in the dental treatment unit. The method may further include connecting external equipment through which data can be transmitted bi-directionally by means of an interface on the dental treatment unit, and configuring the interface for the connection of external equipment in such a way that the interface establishes a connection via the central control unit with the interface of the three-dimensional measuring device for the transmission of data and/or control commands.

The method may yet further include storing and calling up a computer program for processing data from the three-dimensional measuring device by means of a computer with at least one interface, integrating the computer in the central control unit, and/or connecting an interface of the three-dimensional measuring device to an interface of the computer. The method may include triggering functions of the three-dimensional measuring device by control signals of an operating element that belongs to the dental treatment unit, with the operating element being a foot-operated switch, and/or triggering certain functions of the dental treatment unit or of the three-dimensional measuring device by at least two input means on the three-dimensional measuring device and/or on the dental treatment unit.

The method may include recognizing the control commands in the form of sound sequences and/or voice, and converting the control commands to corresponding control signals for carrying out functions of the three-dimensional device by way of recognizing means on the dental treatment unit or on the three-dimensional measuring device or on the computer. The method may also include issuance of the control command and generation of the control signals by elapsing a time gap of less than 0.2 seconds between the issuance and the generation, and/or automatically bringing the treatment chair, dependant on the measurement that is to be effected, into a position that is convenient for an operator of the three-dimensional measuring device by patient positioning means.

The method may yet further include providing the graphic display means on the dental treatment unit, showing measurement-relevant data and/or displays that are output by the computer by at least one of the graphic display means, equipping the computer with a graphic display means, and/or showing different measurement-relevant data and/or displays on the computer graphic display means and on at least one of the graphic display means of the dental treatment unit. The method may include providing the graphic display means of the dental treatment unit with a touch-sensitive and location-resolving surface, and/or providing evaluation means that evaluate pressure upon the surface and transmit control signals to the dental treatment unit, the computer, and/or the three-dimensional measuring device. The method may include showing different kinds of information respectively on several graphic display means, bringing at least one of the graphic display means of the dental treatment unit in a position that is convenient for an operator of the three-dimensional measuring device by motor-driven adjusting means, and/or storing a recording plan in the central control unit and/or in the computer based upon which a position that is convenient for an operator of the three-dimensional measuring device of at least one of the graphic display means of the dental treatment unit and the treatment chair is determined by the central control unit or the computer.

The method may yet further include providing the computer program with means for recognizing a tooth type and a recording direction of the image and further providing evaluation means in order to determine on basis of a recording plan a favorable position for a next necessary image and transmit corresponding control signals via the interface of the computer via the interface of the dental treatment unit to the connection of external equipment to the central control unit in order to control patient positioning means and/or display means of the dental treatment unit. The method may include providing a shelf for the hand-held instrument of the three-dimensional measuring device. The shelf may contain sensing means that recognize the deposition and removal of the hand-held instrument. The method may also include providing signaling means that transmit the status of the shelf via one of the interfaces of the three-dimensional device. The method may further include rendering the dental treatment unit and the computer program called up on the computer into a necessary state for measurement by removal of the hand-held instrument of the three-dimensional measuring device from the shelf, and/or transmitting measured data of the three-dimensional measuring device to a local or remote network on the dental treatment unit, the three-dimensional measuring device and/or the computer by means of an interface.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a schematic depiction of a dental treatment unit according to the present invention, including a three-dimensional measuring device;

FIG. 2A is an enlarged schematic depiction of a three-dimensional measuring device according to the present invention;

FIG. 2B is an enlarged schematic depiction of a dentist's element with integrated components, and an alternative embodiment of a three-dimensional measuring device according to the present invention;

FIG. 3 is a flow-chart of a process for the implementation of taking a three-dimensional measurement; and

FIG. 4 is a flow-chart of a process including tooth recognition and automatic chair positioning.

### DETAILED DESCRIPTION OF THE PREFERRED EMBODIMENT

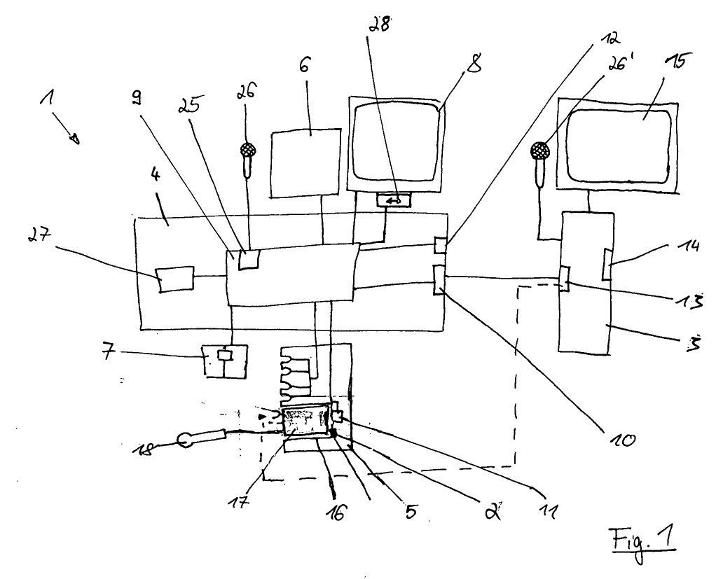

Referring now to the drawings wherein like reference numerals designate corresponding parts throughout the several views, FIGS. 1-4 illustrate a dental treatment unit, a three-dimensional measuring device and related components and processes according to the present invention.

Specifically, referring to FIG. 1, a dental treatment unit 1, a three-dimensional measuring device 2 and a computer 3 are illustrated. Dental treatment unit 1 may include a treatment chair 4, a dentist's element 5, an assistant's element 6, a foot-operated switch 7, a monitor 8 and a central control unit 9.

Dental treatment unit 1 may include, moreover, several interfaces. For example, an interface 10 may serve for connecting external equipment, which in the embodiment illustrated is a computer 3. A further interface 11 may be provided for connecting three-dimensional measuring device 2 to dentist's element 5. Another interface 12 may serve for connecting dental treatment unit 1 to a local or remote network (not shown).

Central control unit 9 may monitor and control all essential functions and interfaces 10, 11, 12 of dental treatment unit 1. Control unit 9 may administer, for example, the control commands by foot-operated switch 7 and dental hand-held instruments (not shown). Central control unit 9 may be connected to assistant's element 4 and control, moreover, monitor 8. Monitor 8 may serve for displaying the status of the dental hand-held instruments and be configured to show the images recorded by three-dimensional measuring device 2, e.g. connected in parallel to monitor 15. Interface 10 may be located on central control unit 9 for connecting an external device, which in the particular embodiment illustrated is computer 3. Central control unit 9 may display data of computer 3 transmitted via interface 10 on monitor 8.

To this end, computer 3 may also include an interface 13 that is connected to interface 10 of dental treatment unit 1. Computer 3 can also have a further interface 14 that makes a network connection for transmitting data possible. As discussed above, computer 3 may include, in addition, monitor 15 through which computer 3 can display data.

Monitors 8 and 15 may indicate both identical as well as differing information, respectively. In the event they each show different information, it is possible, for example, to display on monitor 15, that is connected to computer 3, information related to the administration of data, i.e. patient information, recording data etc., and on monitor 8, that is mounted on dental treatment unit 1, data related to the actual measurement, e.g. before the triggering of an image, the live image of the three-dimensional measuring device 2 or after an image was taken the depiction of the recorded area represented in perspective. However, both monitors 8 and 15 may also display each identical measured data or the same patient-related information, e.g. when monitors 8 and 15 are connected in parallel.

Dentist's element 5 may include a drawer 16 having interface 11 for receiving three-dimensional measuring device 2. Interface 11 may be connected to central control unit 9.

A module 25 may be provided on central control unit 9 for connecting a microphone 26. Module 25 may be configured to recognize sound sequences, e.g. in the form of voice commands, and derive control signals from them almost in real time. The signals may then be used for controlling dental treatment unit 1, three-dimensional measuring device 2 and computer 3. To this end, central control unit 9 may forward the control commands given through microphone 26 via interface 11 to interface 20 of three-dimensional measuring device 2 in order to trigger, for example, a measurement. This can also be achieved by means of microphone 26′ that is connected to computer 3. A measurement may also be triggered by means of foot-operated switch 7, or, depending on the configuration of dental treatment unit 1 via a push-key (not shown) on dentist's element 5 or assistant's element 6.

Furthermore, central control unit 9 may serve for the adjustment of treatment chair 4 using adjustment means 27 and of the monitor using further adjustment means 28.

A treatment plan that is available on computer 3 for the treatment of a patient or a treatment plan entered by way of dentist's element 5 or assistant's element 6 may therefore be used by central control unit 9 to reposition the patient or monitor 8 after the treatment process has been completed, for example, after the taking of an image of a measurement.

Monitors 8 and 15 may each show different measurement-relevant data. Thus, the operator of three-dimensional measuring device 2 may obtain a display of the recorded area via monitor 8, while an assistant views administrative data on computer 3 by way of monitor 15, which is connected there.

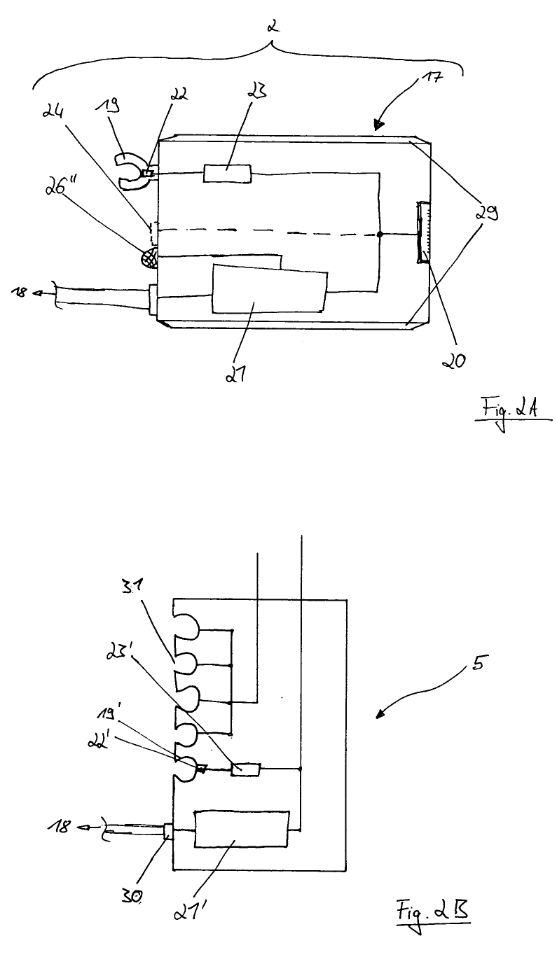

Referring to FIG. 2A, there is shown three-dimensional measuring device 2 by means of a detail in an embodied example. Three-dimensional measuring device 2 may include a base 17, hand-held instrument 18, shelf 19 and interface 20 that is connected to interface 11 of dental treatment unit 1. Hand-held instrument 18, which is not shown in the enlargement, may transmit the measured data to an evaluation unit 21, which in turn forwards the data via interface 20 to dental treatment unit 1. Self 19 may include sensing means 22 that recognizes when hand-held instrument 18 is deposited or removed and then forward that information by means of signaling means 23 also to interface 20. In addition to or alternatively, transmission of data may also be possible by means of another interface 24 (shown as perforated line) that transmits the data to interface 13 of computer 3 (also shown as perforated line). Three-dimensional measuring device 2 may also be supplied with power by means of interface 20, thereby foregoing the need for a separate energy supply. Hand-held instrument 18 may be configured in terms of its dimensions in such a way that it can be inserted into the oral cavity of a patient. Measuring a situation inside the mouth area may be made much easier in this manner because the patient to be examined does not have to change to a different position, and the operator of hand-held instrument 18 can freely position the instrument. Measuring device 2 may include connecting means 29 for connecting inside drawer 16 on the dentist's element provided for this purpose on dentist's element 5. Microphone 26″, which recognizes sound signals or voice commands and triggers measurement functions, may be provided for inputting control commands of three-dimensional measuring device 2.

Referring to FIG. 2B, there is shown an alternative embodied example of dental treatment unit 1 where parts of the three-dimensional measuring device are integrated in dentist's element 5. All necessary parts except for the hand-held instrument may also be stored in treatment unit 1. This may include image acquisition unit 21′, shelf 19′, as well as sensing means 22′ and signaling means 23′. Hand-held piece 18 may be attached to a connection 30 on dentist's element 5 that may be provided for this purpose. Shelf 19′ may be one of the shelves 31 for other treatment instruments.

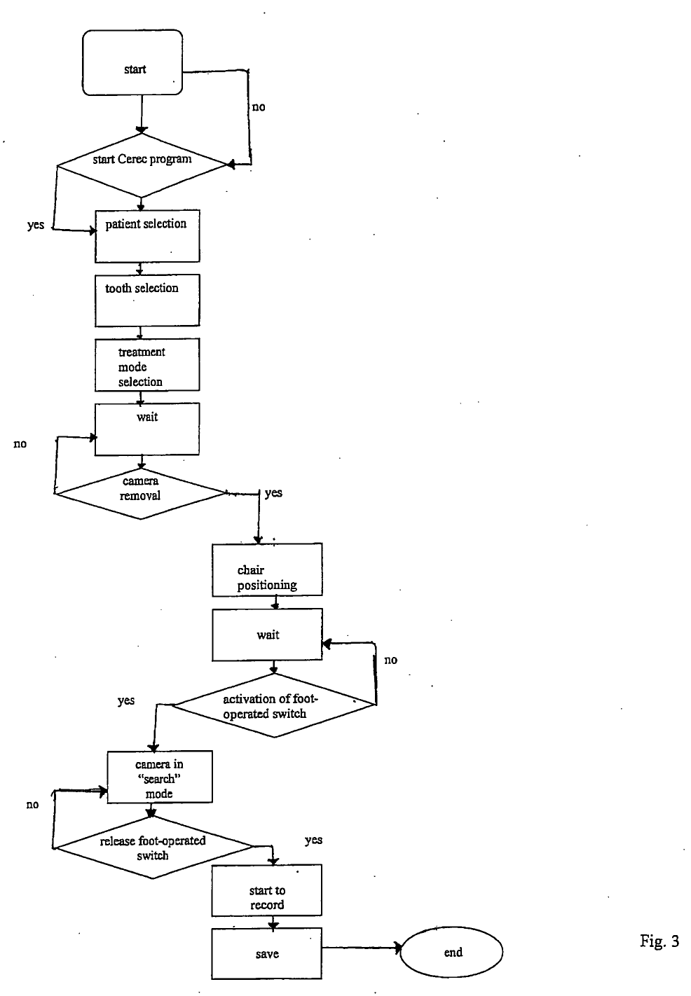

Referring to FIG. 3, there is shown a flowchart depicting the method of taking a three-dimensional measurement using foot-operated switch 5. At the beginning, the person conducting the treatment may call up the needed dental software on computer 3, which in the particular embodiment illustrated is CEREC software. The operator may be asked to subsequently identify the patient, the tooth to be measured and the treatment mode. In this manner, the software may automatically assign the images to the correct file and save exact information about the image.

Now the program may be placed in a waiting mode awaiting a signal by the shelf of the hand-held piece. If the camera was removed, the chair may be repositioned in correspondence with the image to be recorded, if necessary.

When the person conducting the treatment then activates foot-operated switch 7, the camera may be brought into a “search” mode that constantly focuses on a selected area of the image field. The live image of the camera may be displayed in this mode on one of the monitors 8, 15.

Releasing foot-operated switch 7 may then start the measurement of the selected area and the measured data may be saved by the software.

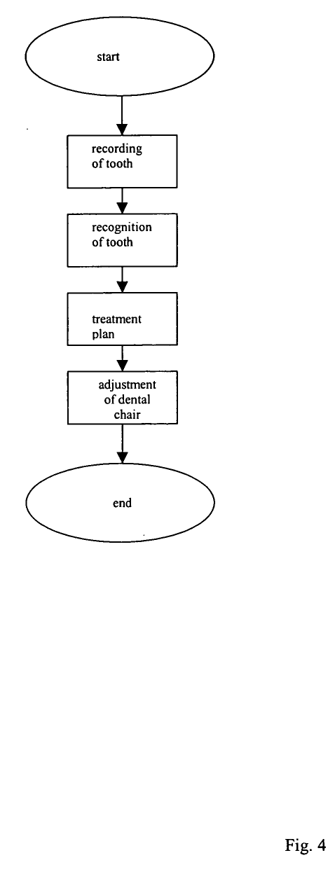

Referring to FIG. 4, there is shown a further flowchart depicting functionality of the dental treatment device. The used software may recognize based on the last effected image what tooth was recorded and from what direction and compare this information with the treatment plan. The software may then know what image must be taken next and transmit to central control unit 9 the control signals regarding the positioning of the patient to adjusting means 27 of dental chair 4. The patient may be automatically brought into a favorable position for the next required image.

To be named by way of an example is a quadrant restoration for which one half of the jaw must be measured. Depending on the area that is to be measured within the quadrant, the head of the patient may be lowered or elevated.

When examining the occlusion between upper and lower jaw, images may be taken from both sides. For the person conducting the measurements, it may be ergonomically advantageous if the patient is repositioned in a horizontal plane and the incline.

Finally to be noted is the measurement of the frontal teeth for which the labial and distal view of the teeth are to be taken. In this instance, a change of the incline of the head rest of treatment chair 4 may be advantageous.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

1. A dental treatment unit comprising at least one mechanical connection for a three-dimensional measuring device for the measurement of teeth, treatment situations and tooth models, said three-dimensional measuring device and said dental treatment unit are connected by means for exchange of at least one of data control commands and supply of power to said three-dimensional measuring device.

2. A dental treatment unit according to claim 1, wherein said dental treatment unit includes a drawer or a shelf in which is inserted or deposited at least a base part of said three-dimensional measuring device.

3. A dental treatment unit according to claim 1, wherein said three-dimensional measuring device is partially integrated in said dental treatment unit.

4. A dental treatment unit as clamed according to claim 3, wherein the connection is mounted on at least one of a dentist's element, on an assistant's element, on a graphic display means and in a treatment chair.

5. A dental treatment unit according to claim 4, wherein the base part of the three-dimensional measuring device is removable by hand.

6. A dental treatment unit a according to claim 1, wherein the three-dimensional measuring device includes a hand-held instrument for recording of an image that transmits the recorded data to an image acquisition unit incorporated in said three-dimensional measuring device where the data are digitized and made available via an interface.

7. A dental treatment unit according to claim 6, further comprising a central control unit in said dental treatment unit, said central control unit controls at least in part functions and interfaces of said dental treatment unit.

8. A dental treatment unit according to claim 7, further comprising an interface on said dental treatment unit for connecting external equipment through which data can be transmitted bi-directionally, and said interface for the connection of external equipment is configured in such a way that the interface establishes a connection via said central control unit with the interface of said three-dimensional measuring device for at least one of the transmission of data and control commands.

9. A dental treatment unit according to claim 8, further comprising computer with at least one interface, said computer is capable of storing and calling up a computer program for processing data from said three-dimensional measuring device.

10. A dental treatment unit according to claim 9, wherein said computer is integrated in said central control unit.

11. A dental treatment unit according to claim 9, wherein an interface of the three-dimensional measuring device is connected to an interface of said computer.

12. A dental treatment unit according to claim 11, wherein functions of said three dimensional measuring device are triggered by control signals of an operating element that belongs to said dental treatment unit, said operating element is a foot-operated switch.

13. A dental treatment unit according to claim 12, further comprising at least two input means on at least one of said three-dimensional measuring device and on said dental treatment unit for triggering certain functions of said dental treatment unit or of said three-dimensional measuring device.

14. A dental treatment unit according to claim 13, further comprising recognizing means on said dental treatment unit or on said three-dimensional measuring device or on said computer that recognize the control commands in the form of at least one of sound sequences and voice, and convert the control commands to corresponding control signals for carrying out functions of said three-dimensional device.

15. A dental treatment unit according to claim 14, wherein a time gap of less than 0.2 seconds elapses between issuance of the control command and generation of the control signals.

16. A dental treatment unit according to claim 15, further comprising patient positioning means that are used to automatically bring said treatment chair, dependant on the measurement that is to be effected, into a position that is convenient for an operator of said three-dimensional measuring device.

17. A dental treatment unit according to claim 16, wherein said at least one graphic display means is provided on said dental treatment unit.

18. A dental treatment unit according to claim 17, wherein at least one of the graphic display means shows at least one of measurement-relevant data and displays that are output by said computer.

19. A dental treatment unit according to claim 18, wherein said computer is equipped with a graphic display means and wherein at least one of different measurement-relevant data and displays are shown on said computer graphic display means and on at least one of the graphic display means of said dental treatment unit.

20. A dental treatment unit according to claim 19, wherein said at least one graphic display means of the dental treatment unit has a touch-sensitive and location-resolving surface, and further includes evaluation means that evaluate pressure upon the surface and transmit control signals to at least one of said dental treatment unit said computer, and said three-dimensional measuring device.

21. A dental treatment unit according to claim 20, wherein, further comprising several graphic display means which are suitable for showing different kinds of information respectively.

22. A dental treatment unit according to claim 21, further comprising motor-driven adjusting means for bringing at least one of the graphic display means of the dental treatment unit in a position that is convenient for an operator of said three-dimensional measuring device.

23. A dental treatment unit according to claim 22, wherein a recording plan is stored in at least one of said central control unit and in said computer based upon which a position that is convenient for an operator of said three-dimensional measuring device of at least one of the graphic display means of the dental treatment unit and said treatment chair is determined by said central control unit or said computer.

24. A dental treatment unit according to claim 23, wherein the computer program contains means for recognizing a tooth type and a recording direction and further includes evaluation means in order to determine on basis of a recording plan a favorable position for a next necessary image and transmits corresponding control signals via the interface of said computer via said interface of said dental treatment unit to the connection of external equipment to said central control unit in order to control at least one of said patient positioning means and display means of said dental treatment unit.

25. A dental treatment unit according to claim 24, further comprising a shelf for the hand-held instrument of said three-dimensional measuring device, and said shelf contains sensing means that recognize the deposition and removal of said hand-held instrument, and further including signaling means that transmit the status of said shelf via one of the interfaces of said three-dimensional device.

26. A dental treatment unit according to claim 25, wherein said dental treatment unit and the computer program called up on the computer is rendered into a necessary state for measurement by removal of said hand-held instrument of said three dimensional measuring device from said shelf.

27. A dental treatment unit according to claim 26, further comprising an interface for transmission of measured data of said three-dimensional measuring device to a local or remote network on at least one of said dental treatment unit, said three-dimensional measuring device and said computer.

28. A three-dimensional measuring device for three-dimensional measuring of teeth, treatment situations and tooth models, said three-dimensional measurement device comprising a hand-held piece with an image acquisition unit and a base unit that is connected to said hand-held piece, said base unit includes means for at least one of change of data and control commands with at least one of a dental treatment unit and means for supply of power through said dental treatment unit.

29. A three-dimensional measuring device according to claim 28, wherein said three-dimensional measuring device is equipped with connecting means for the connection of said three-dimensional measuring device to locations on said dental treatment unit.

30. A three-dimensional measuring device according to claim 29, wherein said connecting means are configured in such a way that said three-dimensional measuring device is detachable by hand from said dental treatment unit.

31. A three-dimensional measuring device according to claim 30, further comprising a shelf for deposition of said hand-held instrument on a base unit.

32. A three-dimensional measuring device according to claim 31, wherein said shelf contains sensing means that transmit status of said shelf via signaling means by way of one of the interfaces of said three-dimensional measuring device.

33. A three-dimensional measuring device according to claim 32, wherein said three dimensional measuring device includes an image acquisition unit where measured data recorded with the three-dimensional measuring device are digitized and made available via an interface.

34. A three dimensional measuring device according to claim 33, wherein said interface is connected to said dental treatment unit.

35. A three-dimensional measuring device according to claim 33, wherein said interface is connected to a computers.

36. A three-dimensional measuring device according to claim 35, wherein image recording functions of said three-dimensional measuring device Scan be triggered by means to effect change of at least one of data and control commands.

37. A three-dimensional measuring device according to claim 36, wherein said means are designed in such a way that said three-dimensional measuring device is able to send measured data to a local or remote network.

38. A three-dimensional measuring device according to claim 36, wherein recognizing means are available on the three-dimensional measuring device that recognize control commands in the form of at least one of sound sequences and voice.

39. A method of measuring teeth, treatment situations and tooth models, said method comprising:
providing a dental treatment unit including at least one mechanical connection for a three-dimensional measuring device; and
connecting said three-dimensional measuring device and said dental treatment unit by said mechanical connection, and thereby at least one of exchanging data, exchanging control commands, and supplying power to said three dimensional measuring device.

40. A method according to claim 39, further comprising inserting or depositing a drawer or shelf on said dental treatment unit on at least a base part of said three-dimensional measuring device.

41. A method according to claim 39, farther comprising partially integrating said three-dimensional measuring device in said dental treatment unit.

42. A method according to claim 41, further comprising mounting said connection on at least one of a dentist's element, on an assistant's element, on a graphic display means and in a treatment chair.

43. A method according to claim 42, wherein the base part of the three-dimensional measuring device is removable by hand.

44. A method according to claim 43, further comprising providing the three-dimensional measuring device with a hand-held instrument for recording of an image that transmits the recorded data to an image acquisition unit incorporated in said three-dimensional measuring device where the data are digitized and made available via an interface.

45. A method according to claim 44, further comprising controlling at least in part functions and interfaces of said dental treatment unit by means of a central control unit in said dental treatment unit.

46. A method according to claim 45, further comprising connecting external equipment through which data can be transmitted bi-directionally by means of an interface on said dental treatment unit, and configuring said interface for the connection of external equipment in such a way that the interface establishes a connection via said central control unit with the interface of said three-dimensional measuring device for at least one of the transmission of data and control commands.

47. A method according to claim 46, further comprising storing and calling up a computer program for processing data from said three-dimensional measuring device by means of a computer with at least one interface.

48. A method according to claim 47, further comprising integrating said computer in said central control unit.

49. A method according to claim 47, further comprising connecting an interface of the three-dimensional measuring device to an interface of said computer.

50. A method according to claim 49, further comprising triggering functions of said three-dimensional measuring device by control signals of an operating element that belongs to said dental treatment unit, said operating element is a foot-operated switch.

52. A method according to claim 51, further comprising triggering certain functions of said dental treatment unit or of said three-dimensional measuring device by at least two input means on at least one of said three-dimensional measuring device and on said dental treatment unit.

53. A method according to claim 52, further comprising recognizing the control commands in the form of at least one of sound sequences and voice, and converting the control commands to corresponding control signals for carrying out functions of said three-dimensional device by way of recognizing means on said dental treatment unit or on said three-dimensional measuring device or on said computer.

54. A method according to claim 53, further comprising issuance of the control command and generation of the control signals by elapsing a time gap of less than 0.2 seconds between said issuance and said generation.

55. A method according to claim 54, further comprising automatically bringing said treatment chair, dependant on the measurement that is to be effected, into a position that is convenient for an operator of said three-dimensional measuring device by patient positioning means.

56. A method according to claim 55, further comprising providing said at least one graphic display means on said dental treatment unit.

57. A method according to claim 56, further comprising showing at least one of measurement-relevant data and displays that are output by said computer by at least one of the graphic display means.

58. A method according to claim 57, further comprising equipping said computer with a graphic display means, and showing at least one of different measurement-relevant data and displays on said computer graphic display means and on at least one of the graphic display means of said dental treatment unit.

59. A method according to claim 58, further comprising providing said at least one graphic display means of the dental treatment unit with a touch-sensitive and location-resolving surface, and providing evaluation means that evaluate pressure upon the surface and transmit control signals to at least one of said dental treatment unit, said computer, and said three-dimensional measuring device.

60. A method according to claim 59, further comprising showing different kinds of information respectively on several graphic display means.

61. A method according to claim 60, further comprising bringing at least one of the graphic display means of the dental treatment unit in a position that is convenient for an operator of said three-dimensional measuring device by motor-driven adjusting means.

62. A method according to claim 61, further comprising storing a recording plan in at least one of said central control unit and in said computer based upon which a position that is convenient for an operator of said three-dimensional measuring device of at least one of the graphic display means of the dental treatment unit and said treatment chair is determined by said central control unit or said computer.

63. A method according to claim 62, further comprising providing the computer program with means for recognizing a tooth type and a recording direction of the image and further providing evaluation means in order to determine on basis of a recording plan a favorable position for a next necessary image and transmit corresponding control signals via the interface of said computer via said interface of said dental treatment unit to the connection of external equipment to said central control unit in order to control at least one of said patient positioning means and display means of said dental treatment unit.

64. A method according to claim 63, further comprising providing a shelf for the hand-held instrument of said three-dimensional measuring device, said shelf contains sensing means that recognize the deposition and removal of said hand-held instrument, and further including providing signaling means that transmit the status of said shelf via one of the interfaces of said three-dimensional device.

65. A method according to claim 64, further comprising rendering said dental treatment unit and the computer program called up on the computer into a necessary state for measurement by removal of said hand-held instrument of said three-dimensional measuring device from said shelf.

66. A method according to claim 65, further comprising transmitting measured data of said three-dimensional measuring device to a local or remote network on at least one of said dental treatment unit, said three-dimensional measuring device and said computer by means of an interface.
